(19) United States
(12) Patent Application Publication
(10) Pub. No.: US 2002/0069299 A1
(43) Pub. Date: Jun. 6, 2002

(54) Method for synchronizing clocks

(76) Inventors: Douglas K. Rosener, Santa Cruz, CA (US); Peter E. Fine, Santa Cruz, CA (US)

Correspondence Address: Albert P. Halluin, HOWREY SIMON ARNOLD & WHITE, LLP, 1299 Pennsylvania Avenue, N.W., Washington, DC, 20004-2402, US

(21) Appl. No.: 09/728,742

(22) Filed: Dec. 1, 2000

(51) Int. Cl. G06F 15/16

(52) U.S. Cl. 709/248

(57) ABSTRACT

A method and apparatus for synchronizing a clock by means of a wireless communication link is herein disclosed. At least one system client accesses at least one time reference server via a wireless communications link. The time reference server comprises, at a minimum, a clock reference, a processor and a wireless communication adapter. Each client comprises, at a minimum, a settable clock, a processor and a wireless communication adapter. In one embodiment of the invention, the time reference is sent from the time server to a client in response to a request from the client. In another embodiment, the time reference is sent from the time server to a client at predetermined times, without the need for a request from the client. Thus, in such an embodiment, the time server is able to locate clients automatically over the wireless communications link. In yet another embodiment of the invention, a client may select which of a plurality of time reference servers to access in order to receive time reference information.

### FIELD OF THE INVENTION

The present invention pertains to the field of wireless data transfer. More particularly, the present invention relates to synchronization of a time clock over a wireless communication system.

### BACKGROUND OF THE INVENTION

In homes, offices and in industry, accurate measurement of time is required in a wide variety of applications. Many electronic devices display time and/or date information, but the time and/or date is set by the user, and is therefore prone to error. One example of a need for accurate time settings is in current video tape recorders including an internal clock which identifies the current date and time, and which is designed to be used in conjunction with a pre-programmed recording function to record a video signal transmitted over a designated channel at a specific future date or time. In such a system, the time and date must be accurately set by the user in order to for the designated channel signal to be properly and fully recorded.

Another example involves security systems. Some security systems can be pre-programmed to lock and unlock certain doors at certain specific times. An incorrect time setting may lead to premature or tardy operation.

A further example involves computers networked together, wherein an imprecise time set by a user may lead to application problems when files are time stamped with creation times not accurately reflecting when they were actually created or modified. Additionally, accurate time of day measurements are required in managing and tracking electronic mail (e-mail), in timing back-ups of data on a network, in synchronizing communications between clients and servers, and in managing multimedia teleconferences.

Other applications include domestic usage clocks such as for kitchen devices including ovens or coffee makers which can be programmed to start and stop operation based upon pre-selected times, as well as simple time display clocks, all of which are subject to inaccuracies and power disruptions.

Industrial machinery and equipment may also include time clocks which can start and stop machine operations based upon time settings. These and other applications of clocks may benefit from updates by the present invention, as would be obvious to one skilled in the art. Many other types of clocks which may be linked to the present invention for clock synchronizing may be found in homes, workplaces, vehicles, and also in handheld and personal electronic devices.

Accordingly, because the time clocks maintained by most electronic devices and systems tend to be subject to a certain amount of error, or “drift”, as well as being subject to power outages and fluctuations, there is a need to efficiently and accurately synchronize clocks to one or more standard reference clocks from time to time in order to maintain their functionality and accuracy.

Patents which relate to the subject matter of the present invention include U.S. Pat. Nos. 5,557,585; 5,689,688; 5,809,426; 6,023,769; 6,028,853 and 6,118,320. These and all other U.S. patent applications and patents cited herein are each hereby specifically incorporated herein in their entirety by reference.

### SUMMARY OF THE INVENTION

A method and apparatus for synchronizing a clock by means of a wireless communication link is herein disclosed. At least one system client accesses at least one time reference server via a wireless communications link. The time reference server comprises, at a minimum, a clock reference, a processor and a wireless communication adapter. Each client comprises, at a minimum, a settable clock, a processor and a wireless communication adapter. In one embodiment of the invention, the time reference is sent from the time server to a client in response to a request from the client. In another embodiment, the time reference is sent from the time server to a client at predetermined times, without the need for a request from the client. In such an embodiment, the time server is able to locate clients automatically over the wireless communications system. In yet another embodiment of the invention, a client may distinguish between and select which of a plurality of time reference servers to access in order to receive time reference information. Furthermore, in another embodiment, the present invention may be programmable to allow for various time formats, time adjustments and predetermined times for update, of selected clients. The server may also in some embodiments, be enabled to support wireless communication over more than one frequency band and/or protocol. Further embodiments would additionally allow localized delivery of time updates from a server to one or more clients, some of which are delivered via signals sent by the server without the establishment of a two way communication link.

These and other features of the present invention will be apparent to those of skill A in the art from the accompanying drawings and from the detailed description and claims that follow.

### BRIEF DESCRIPTION OF THE DRAWINGS

The present invention is illustrated by way of example and not limitation in the figures of the accompanying drawings, in which references indicate similar elements and in which:

FIG. 1 illustrates a plurality of client systems capable of accessing a time reference server.

FIG. 2 illustrates one specific embodiment of the present invention, in which the time server incorporates temporal information from a GPS satellite in time information sent to client systems over a Bluetooth® technology-based wireless communication link.

FIG. 3 illustrates the same functionality as FIG. 2, except the application processors are embedded in the modules. The settable clock in the client is a register in the Bluetooth module.

FIGS. 4a and 4b. illustrate two halves of a schematic wiring diagram for a Bluetooth wireless communication adapter.

FIG. 5 illustrates examples of programmable features for clock server and a plurality of clients.

FIG. 6 illustrates examples of programmable features for a clock client

### DETAILED DESCRIPTION OF SPECIFIC EMBODIMENTS

The present invention comprises a clock reference server, a wireless communication system, and one or more clock clients which provide for an automatic, programmable, real-time clock synchronization system.

The clock reference server comprises, at a minimum, a clock reference, a server wireless communication adapter, and a server processor running server application software. The clock reference can be either free running or synchronized to other references sources. The clock reference provides the basis for synchronization of all client clocks in the system. It should be noted that the server processor need not be distinct and may be part of the server wireless communication adapter or it may be part of the clock reference.

Each client comprises, at a minimum, a settable client clock, a client wireless communication adapter, and a client processor running client application software. It should be noted that the client processor need not be distinct, and can be part of the client wireless communication adapter or the client clock. The settable client clock can be as simple as a display register, or complicated (e.g., computer processors and mechanical devices linked to a clock). Likewise, the client clock need not be distinct, and may be part of a larger system. The client clocks receive time reference standard information from the time reference server. The clients can display the time of their clocks or use the time information of their clocks to run client application software and/or hardware.

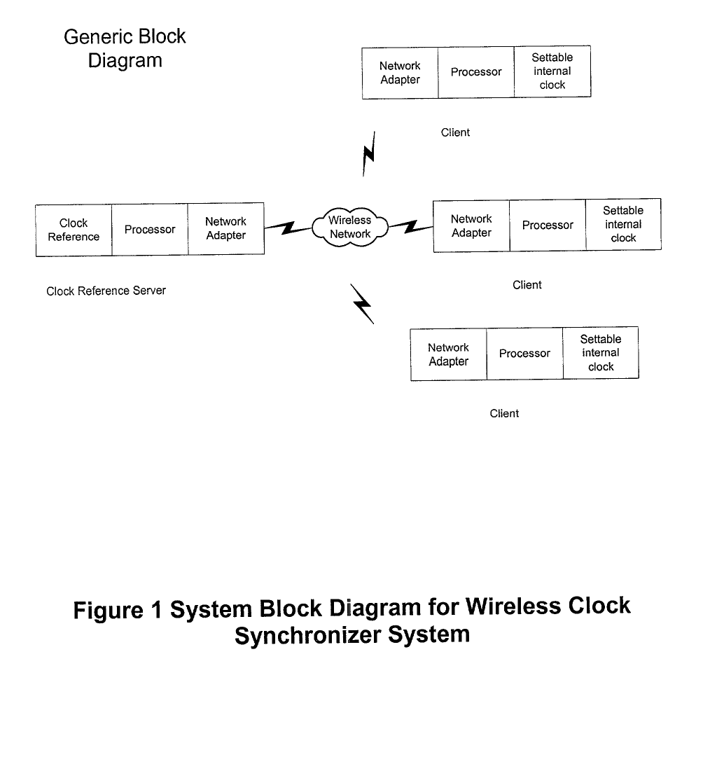

A plurality of clock clients may make use of the time reference server. A generic block diagram of one such embodiment is depicted in FIG. 1.

In one embodiment of the invention, clients establish a wireless communication link intermittently, periodically, or continuously. While connected, clients may request time standard information from the time reference server once, intermittently or periodically. In response to the client request, the time server sends its time information (which may include date information as well) to clients.

In another embodiment of the invention, the time reference information can be delivered to each client in the form of a subscription. In such an embodiment, when subscribed to, the server will periodically update each client over a wireless communication link without the client having to make a request. This may require that a client be either continuously connected through a link or be in such a state that the server can request that the client establish a communication link.

### EXAMPLE 1

### Client Initiated Operation

The time reference server is powered-up by the user. It may have a battery backup to prevent loss of correct time in case of power outage or fluctuation. When a client is powered-up, the client application software determines if a wireless link can be established with a server. If available, a wireless link is established between the client and the server. The client then sends a request for a time update.

The time reference server application software receives the request and sends the time information over the wireless link to the client application. The client application takes the time information update, decodes it and sets the settable client clock with the value supplied. The client clock displays the time information and/or uses the time information to coordinate the operation of other client application software and/or client functions.

At a preset interval determined by the client application software, the client application may send periodic requests over a wireless link for a time information update from the time server. Accordingly, the client clock maintains time synchronization with the time standard of the time server, with only minor errors between update request intervals.

### EXAMPLE 2

### Client Initiated Subscription to Time Server

The time reference server is powered-up by the user. It may have a battery backup. When a client is powered-up, the client application software determines if a wireless communication link is can be established with a server. If available, a wireless link is established between the client and the server. The client then sends a request for a time update. Included in this request is the interval at which the time reference server will send additional time information updates to the client, i.e., a subscription to additional time information updates from the time server. Thereafter, at the specified periodic intervals, the time server automatically accesses the client and sends time information updates to the client. The specified periodic interval for receiving time information updates from the time server is altered by the client user as needed.

### EXAMPLE 3

### Server Initiated

The time reference server is powered-up by the user. It may have a battery backup. At power-up, the server application software determines if a wireless communication link can be established with any client devices. If available, the server forms a wireless link, and then sends time information updates to each client. It continues to send time information updates at an interval specified by the server user. The client application takes the time information update, decodes it and sets its client clock with the information supplied.

### EXAMPLE 4

### Time Server with GPS Module and Bluetooth® System

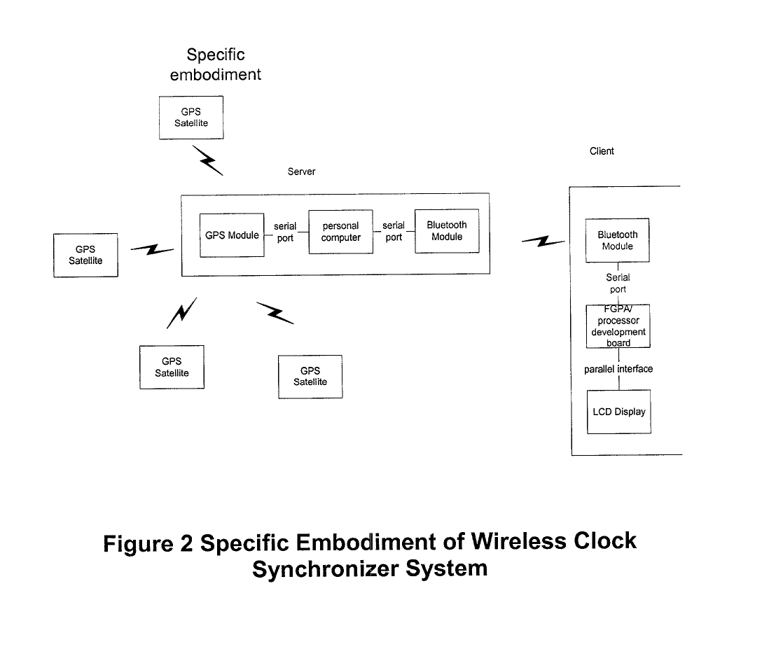

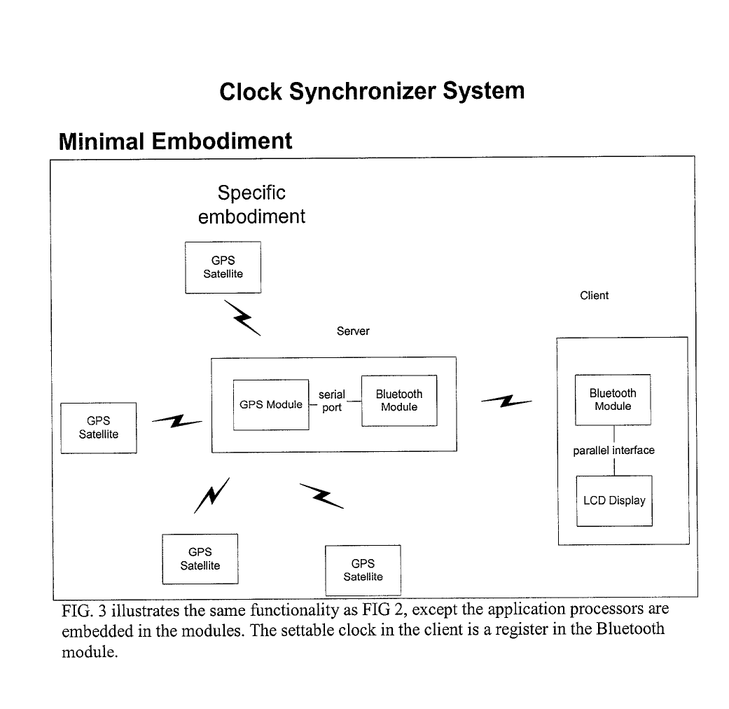

Referring to FIG. 2, the time server consists of a global positioning satellite (GPS) module, such as a Swift Bit OEM Receiver from Axiom Navigation, Inc., a Bluetooth® evaluation system, such as Casira® from Cambridge Silicon Radio, and server application software running on a personal computer. Alternatively, the server could comprise only the GPS module and a Bluetooth® module, with the server application software running on either the GPS module internal processor or the Bluetooth® module internal processor. FIG. 3 illustrates the same functionality as FIG. 2, except the application processors are embedded in the modules. The settable clock in the client is a register in the Bluetooth module.

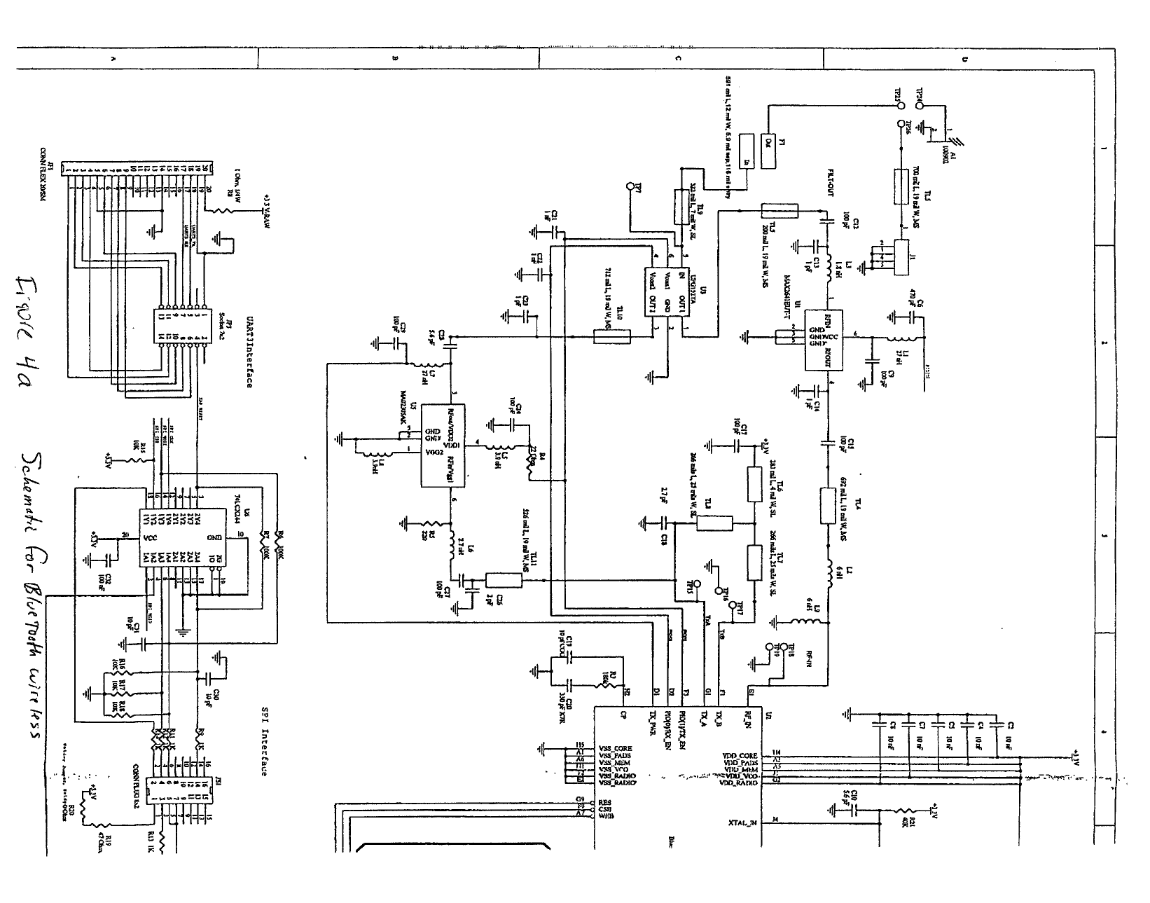

The client system includes a Bluetooth® module, using a BC01 from Cambridge Silicon Radio as shown in the schematic diagrams of FIGS. 4a and 4b, a FPGA/Processor development board, such as those available from Altera Excalibur, and client application software running on the development board as could be readily built by a person of average skill in the art without the need for undue experimentation. Alternatively, the client system would include a Bluetooth® module and a clock with the client application software running on the Bluetooth® module's internal processor.

The GPS module initialization software is programmed to be in National Marine Electronics Association (NMEA) standard 0183 mode at power-up. This standard continuously transmits ASCII encoded messages at 4800 BAUD, several of which contain date and time information. In this embodiment, GPRMC messages are used. Accordingly, when the time server application software begins running, it will confirm that its GPS module has communication access with a GPS satellite prior to transmitting time information to clients over the wireless communication link.

The Bluetooth® module in the time reference server acts as a master device. It contains a serial port which is connected to the personal computer of the server system. The GPS module is also connected to a serial port.

Whenever a clock client is powered up, it is placed in “Bluetooth® limited discovery mode” as a Bluetooth® RFCOMM serial port. The Bluetooth® master periodically performs a limited inquiry to search for client serial ports. When one is found, it is assigned a serial port and a connection with the client is established. Up to 255 clients can be serviced with this current Bluetooth technology system.

Subsequent to connection with the client, time information is transmitted to the client. The client uses this time information to set its client clock. Subsequently, the connection between the server and the client is released.

In this specific embodiment, the client clock consists of a processor timer and a register to hold the date. Both are implemented on the FPGA/processor development board. The timer is programmed to increment every second via an interrupt. The date and time are displayed on the LCD display that comes with the Altera Excalibur development system and is connected via a parallel port. When the timer exceeds 24 hours, it is reset to 0 and the date is incremented.

When the time information updates arrives from the time server, the date register is loaded with the date information, and the timer is loaded with the time information. In this specific embodiment, the time server is programmed to do a limited inquiry and to send date and time updates every hour. In this specific embodiment, the client clock maintains accuracy within one second of GPS time.

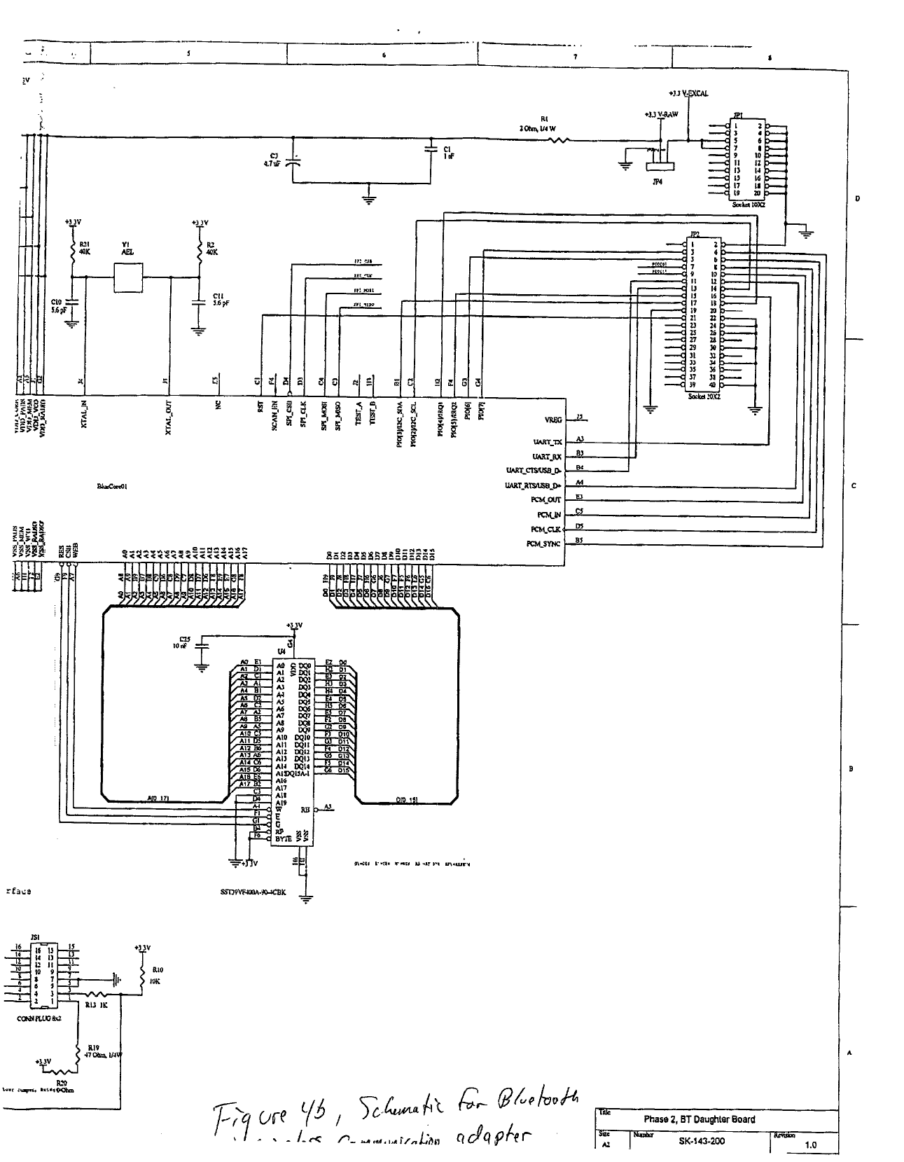

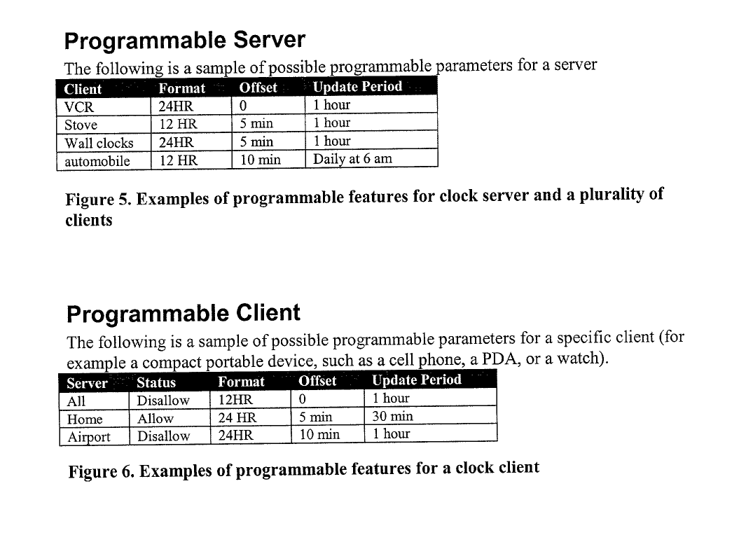

It should be particularly noted, that in another embodiment, local user controlled programmable features may be enabled where, for example, separate clients may receive time synchronization information on distinct and separate intervals and also in different time formats, as compared to other client devices. FIGS. 5 and 6 show examples of such an embodiment where Time format, Time offset from real time and Time update period are set with different values for a variety of typical home devices containing clocks. In this example, The VCR would be set to exact local time to allow accurate recording starting and stopping points, while most of the simple display clocks in the home are set 5 minutes ahead of actual local time, and time setting in a vehicle parked in a garage can be set 10 minutes ahead of local time. The programming to adjust such parameters can be programmed either within the server processor or within each client processor, where such programming could be easily performed for the particular processor and function desired by a person of ordinary skill in the art. Format of displayed time can similarly be set, for example, 12 hour AM/PM settings on one device, and 24 hour format on another device. Different time zone formats can also be displayed by additional client devices. Any number of programmable features could be enabled either within the server or the client devices, as would be obvious to one skilled in the art.

Within another embodiment, the server clock can provide wireless clock synchronization to a plurality of client clocks, over more than one frequency band and/or wireless protocol. An example of such an embodiment, could be enabled by a server device featuring multi-band frequency capability such as 824-894 MHz, 1850-1990 MHz, and 2.4-2.5 GHz bands, and/or multiple protocol capability such as cell phone protocol CDMA, PCS and Bluetooth® protocol. Such a device could then update a client clock on one or more cellular phone protocols, and also could update client clock devices over the Bluetooth® or IEEE 802.11 WLAN data transfer protocols.

Similarly, another embodiment would allow periodic clock updates to some client devices with a local user controlled one-way wireless broadcast update, without the need to establish a two way wireless communication link, as is typically done via the Bluetooth® protocol.

While the present invention has been particularly shown and described in conjunction with certain specific embodiments thereof, it will be readily appreciated by those of ordinary skill in the art that various changes may be made without departing from the spirit and scope of the invention. Accordingly, it is intended that the appended claims be interpreted as including the embodiments described herein, the alternatives mentioned above and all equivalents thereto.

What is claimed is:

1. A method for synchronizing a clock, the method comprising:
providing from a remote server over a wireless communication link a time standard to at least one local client;
wherein,
the server comprises a clock reference, a wireless communication adapter and a processor capable of running server application software; and
the client comprises a settable clock, a wireless communication adapter and a processor capable of running client application software.

2. The method of claim 1, wherein the clock reference of the server is either free running or synchronized to other reference sources.

3. The method of claim 1, wherein the settable clock of the client is either a display register or an internal clock used to synchronize other functions of the client.

4. The method of claim 1, wherein the time standard is provided by the server to the client only as a result of a request from the client.

5. The method of claim 1, wherein the time standard is provided by the server to the client without having received a request from the client.

6. The method of claim 5, wherein the time standard is provided by the server to each client in a manner that minimizes access load on the server.

7. The method of claim 1, wherein the client can select that the time standard be provided by any one of a plurality of servers.

8. The method of claim 1, wherein the clock reference is controlled by a user of the client.

9. A device for synchronizing clocks, the device comprising:
server means for providing a time standard over a wireless communication link;
client means for receiving the time standard from the server means;
wherein,
the server means comprises a clock reference, a wireless communication adaptor and a processor capable of running server application software; and
the client means comprises a settable clock, a wireless communication adapter and a processor capable of running client application software.

10. The device of claim 9, wherein the clock reference of the server means is either free running or synchronized to other reference sources.

11. The device of claim 9, wherein the settable clock of the client means is either a display register or an internal clock used to synchronize other functions of the client.

12. The device of claim 9, wherein the time standard is provided by the server means to the client means only as a result of a request from the client means.

13. The device of claim 9, wherein the time standard is provided by the server means to the client means without having received a request from the client means.

14. The device of claim 9, wherein the time standard is provided by the server means to each client means in a manner that minimizes access load on the server means.

15. The device of claim 9, wherein the client means can select that the time standard be provided by any one of a plurality of server means.

16. The device of claim 9, wherein the clock reference is controlled by a user of the client means.

17. A system comprising:
a client processor;
a wireless communication adapter functionally coupled to the client processor for enabling the system to communicate over a wireless communication link; and
a client storage device functionally coupled to the client processor, the client storage device having instructions stored therein which configure the client processor to receive a time standard from a reference server;
wherein,
said reference server comprises:
a server processor,
a wireless communication adapter functionally coupled to the server processor for enabling the system to communicate over a wireless communication link; and
a server storage device functionally coupled to the server processor, the server storage device having instructions stored therein which configure the server processor to send a time standard to the client server.

18. The system of claim 17, wherein the clock reference of the server is either free running or synchronized to other reference sources.

19. The system of claim 17, wherein the settable clock of the client is either a display register or an internal clock used to synchronize other functions of the client.

20. The system of claim 17, wherein the time standard is provided by the server to the client only as a result of a request from the client.

21. The system of claim 17, wherein the time standard is provided by the server to the client without having received a request from the client.

22. The system of claim 17, wherein the time standard is provided by the server to each client in a manner that minimizes access load on the server.

23. The system of claim 17, wherein the client can select that the time standard be provided by any one of a plurality of servers.

24. The system of claim 17, wherein the clock reference is controlled by a user of the client.

25. A data signal embodied in a propagation medium, the data signal representing a plurality of instructions which, when executed on a system, cause the system to:
provide from a remote server over a wireless communication link a time standard to at least one local client;
wherein,
the server comprises a clock reference, a wireless communication adaptor and a processor capable of running server application software; and
the client comprises a settable clock, a wireless communication adapter and a processor capable of running client application software.

26. The data signal of claim 25, wherein the clock reference of the server is either free running or synchronized to other reference sources.

27. The data signal of claim 25, wherein the settable clock of the client is either a display register or an internal clock used to synchronize other functions of the client.

28. The data signal of claim 25, wherein the time standard is provided by the server to the client only as a result of a request from the client.

29. The data signal of claim 25, wherein the time standard is provided by the server to the client without having received a request from the client.

30. The data signal of claim 25, wherein the time standard is provided by the server to each client in a manner that minimizes access load on the server.

31. The data signal of claim 25, wherein the client can select that the time standard be provided by any one of a plurality of servers.

32. The data signal of claim 25, wherein the clock reference is controlled by a user of the client.

33. The method of claim 1, wherein the server is capable of wireless communication over a plurality of frequency bands and/or wireless communication protocols.

34. The method of claim 33, wherein the server is capable of providing time updates to a plurality of clients over a plurality of frequency bands and/or wireless communication protocols.

35. The method of claim 1, wherein the server is capable of providing the time standard to the client by means of a one-way wireless communication broadcast.

36. The method of claim 1, wherein the server is capable of being programmed by a local user to control delivery of a time standard to selected clients.

37. The method of claim 36, wherein programming can be used to control parameters selected from the group of; time format, time adjustment, period of update, and time of update, for each of a plurality of clients.

38. The device of claim 9, wherein the server is capable of wireless communication over a plurality of frequency bands and/or wireless communication protocols.

39. The device of claim 38, wherein the server is capable of providing time updates to a plurality of clients over a plurality of frequency bands and/or wireless communication protocols.

40. The device of claim 9, wherein the server is capable of providing the time standard to the client by means of a one-way wireless communication broadcast.

41. The device of claim 9, wherein the server is capable of being programmed by a local user to control delivery of a time standard to selected clients.

42. The device of claim 41, wherein programming can be used to control parameters selected from the group of; time format, time adjustment, period of update, and time of update, for each of a plurality of clients.
